(19) United States
(12) Patent Application Publication
(10) Pub. No.: US 2006/0278063 A1
(43) Pub. Date: Dec. 14, 2006

(54) Violin practice reminder

(76) Inventor: Ping Sen Liao, Kaohsiung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/150,201

(22) Filed: Jun. 13, 2005

(51) Int. Cl. G09B 15/06

(52) U.S. Cl. 84/465

(57) ABSTRACT

A violin practice reminder includes restriction rods, fixtures, touch rods and a warning unit. The restriction rods, the touch rods and the warning unit are disposed on the fixtures. The restriction rods and the touch rods are made of electric material. Each of the restriction rods has two sections inserted into a sleeve to adjust the length of the restriction rod. The fixtures are secured to a violin. Each of the touch rods is a spiral shape to sleeve onto the restriction rod with washers at respective ends to insulate the touch rod from the restriction rod. The warning unit includes a buzzer and a switch. The switch is connected to the touch rods and the restriction rods, respectively. When the touch rods are in touch with the restriction rods, the switch is turned on to trigger the buzzer to buzz.

### BACKGROUND OF THE INVENTION

1. Field of the Invention

The present invention relates to a violin practice reminder, and more particularly, to a violin having a warning system to remind a learner to correct his/her position when holding the bow incorrectly.

2. Description of the Prior Art

It is always important for a violin learner to hold the bow in a correct position. Sometimes, the learner does not know if he/she holds the bow incorrectly unless someone corrects him/her, otherwise, it is hard to correct the position in the future.

Traditionally, an instructor will stand next to him/her to instruct any incorrect position when holding the bow, however, if the learner practices alone, he/she may not understand whether his/her position is correct or not. Therefore, the present invention is to help the learner correct his/her position when holding the bow correctly.

### SUMMARY OF THE INVENTION

It is the primary object of the present invention to provide a violin practice reminder, which has a warning system to remind a learner to hold the bow in a correct position.

To achieve the primary object, the present invention includes restriction rods, fixtures, touch rods and a warning unit. The restriction rods and the touch rods are made of electric material. The restriction rods, the touch rods and the warning unit are disposed on the fixtures. The fixtures are secured on a violin. Each of the touch rods is a spiral shape to sleeve onto the restriction rod with washers at respective ends to insulate the touch rod from the restriction rod. The warning unit includes a buzzer and a switch. The switch is connected to the touch rods and the restriction rods, respectively. When the touch rods are in touch with the restriction rods, the switch is turned to trigger the buzzer to buzz.

Each of the restriction rods has two sections inserted into a sleeve to adjust the length of the restriction rod. The sleeve further comprises a pair of threads inwardly with one in a clockwise direction and the other in a counterclockwise direction. The horizontal portions of the two sections of each restriction rod are provided with threads to mesh with the threads of the sleeve. The threads of the two sections of the restriction rod are in opposite directions. By rotating the sleeve, the length of the restriction rod will be adjusted.

The control chip of the warning unit is activated to trigger the buzzer to sound the same sound or different sounds when the switch is turned on every time.

### BRIEF DESCRIPTION OF THE DRAWINGS

FIG. 1 is an exploded view of the present invention;

FIG. 2 is a perspective view of a violin incorporated with the present invention;

FIG. 3 is a circuitry diagram of the present invention;

FIG. 4 is a top view of the present invention;

FIG. 5 is a cross-sectional view of the present invention;

FIG. 6 is a top view of the present invention in an operating status;

FIG. 7 is a circuitry diagram of a second embodiment of the present invention, and

FIG. 8 is a circuitry diagram of a third embodiment of the present invention.

### DETAILED DESCRIPTION OF THE PREFERRED EMBODIMENT

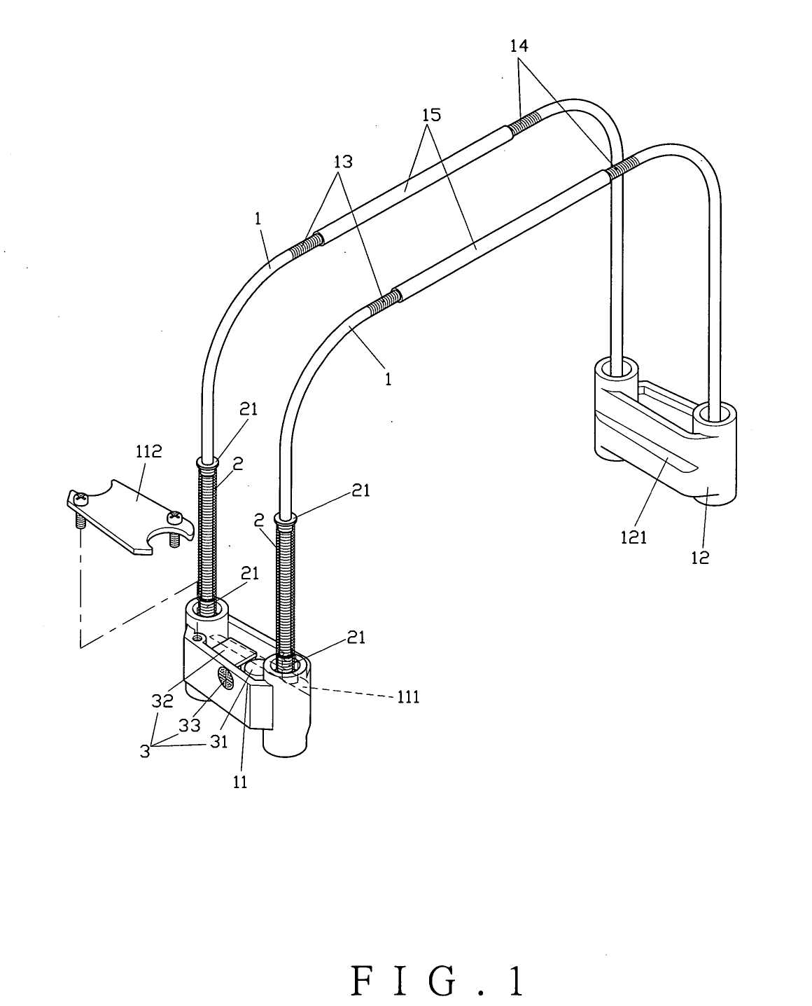

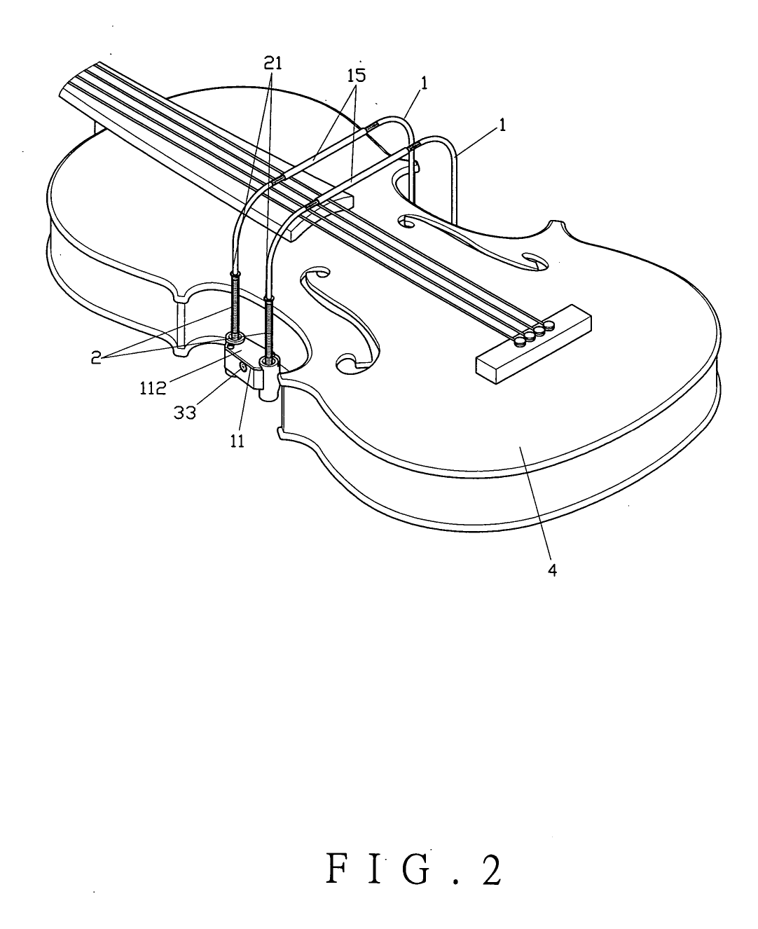

As shown in FIGS. 1 and 2, the present invention comprises a pair of restriction rods 1, a pair of touch rods 2, and a warning unit 3, all of which are disposed on a violin 4. Since the pair of the restriction rods 1 and the pair of touch rods 2 are identical with themself, only one will be described hereinafter.

The restriction rod 1 is made of electric material and is bent with two ends secured to a pair of fixtures 11 and 12, respectively. The fixtures 11 and 12 are provided with slots 111 and 121 at the opposing inner sides. The warning unit 3 is disposed in the fixture 11 and covered with a lid 112. The restriction rod 1 further comprises two sections inserted into a sleeve 15 so as to adjust the length of the restriction rod 1. The sleeve 15 comprising a pair of threads inwardly with one in a clockwise direction and the other in a counterclockwise direction. The horizontal portions of the two sections of the restriction rod 1 are provided with threads 13 and 14 to mesh with the threads of the sleeve 15. The threads 13 and 14 are in opposite directions. By rotating the sleeve 15, the length of the restriction rod 1 will be adjusted.

The touch rod 2 is also made of electric material in a spiral shape. The touch rod 2 is provided with insulating washers 21 at respective ends to insulate from the restriction rod 1. The touch rod 2 is disposed on the fixture 11.

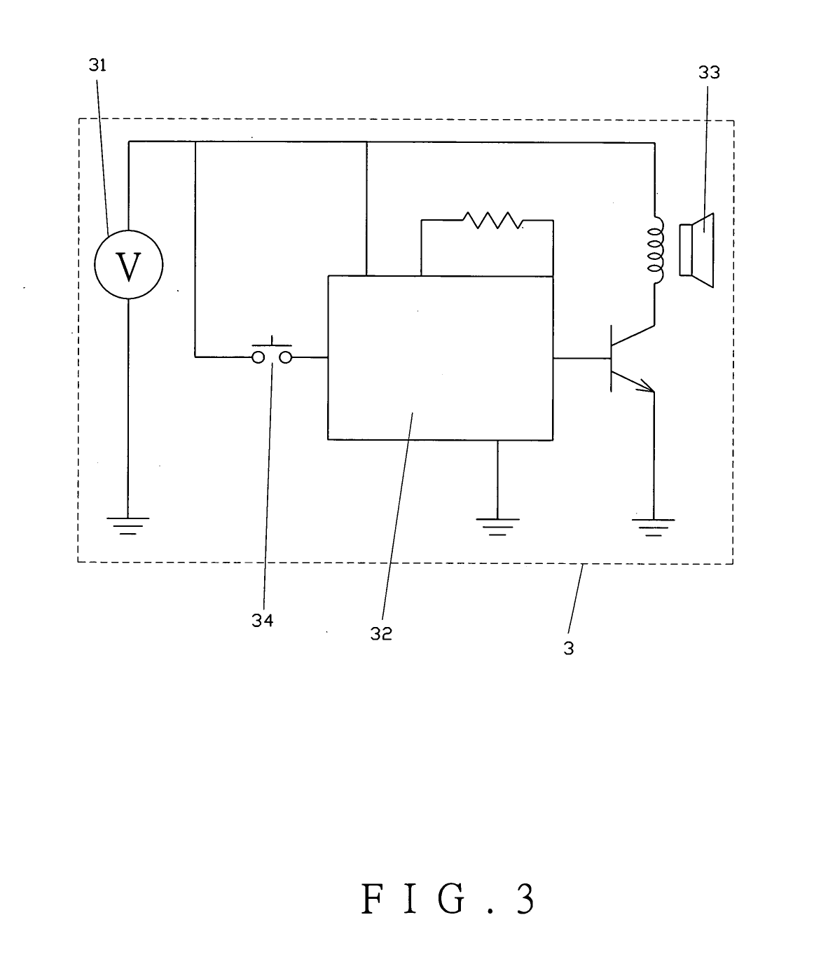

As shown in FIG. 3, the warning unit 3 secured in the fixture 11 includes a battery 31, a control chip 32, a buzzer 33, and a switch 34. The switch 34 is connected to the restriction rod 1 and the touch rod 2, respectively. When the touch rod 2 is in touch with the restriction rod 1, the switch 34 is switched on and the battery 31 provides electricity to trigger the buzzer 33 to buzz the same sound. When the touch rod 2 is released from the restriction rod 1, the switch 31 is switched off and the buzzer 33 stops buzzing.

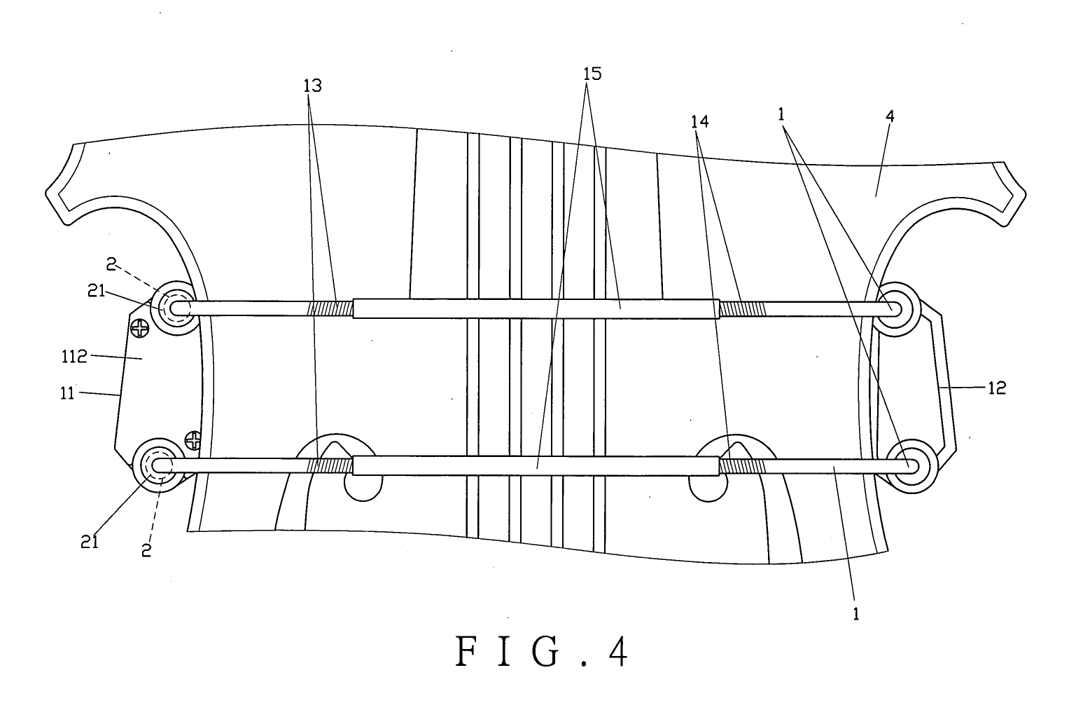

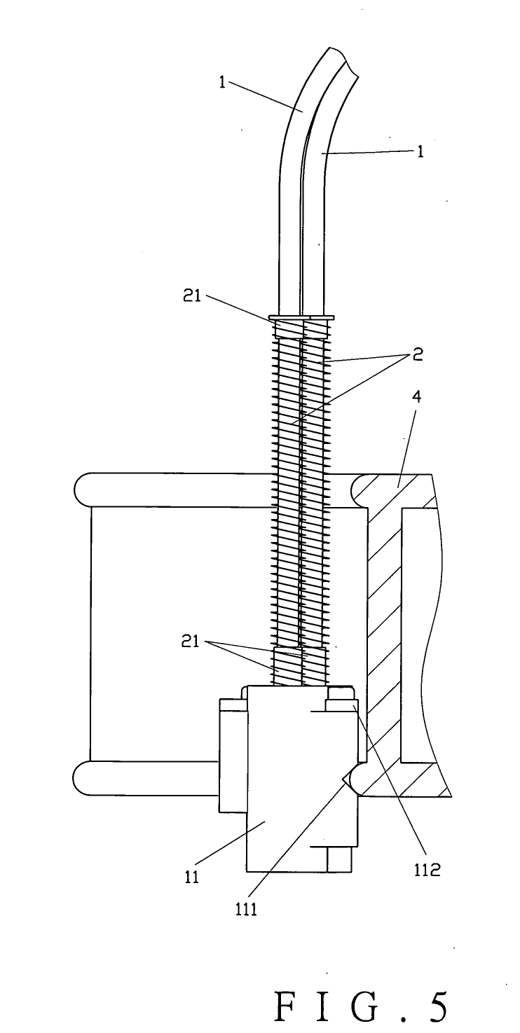

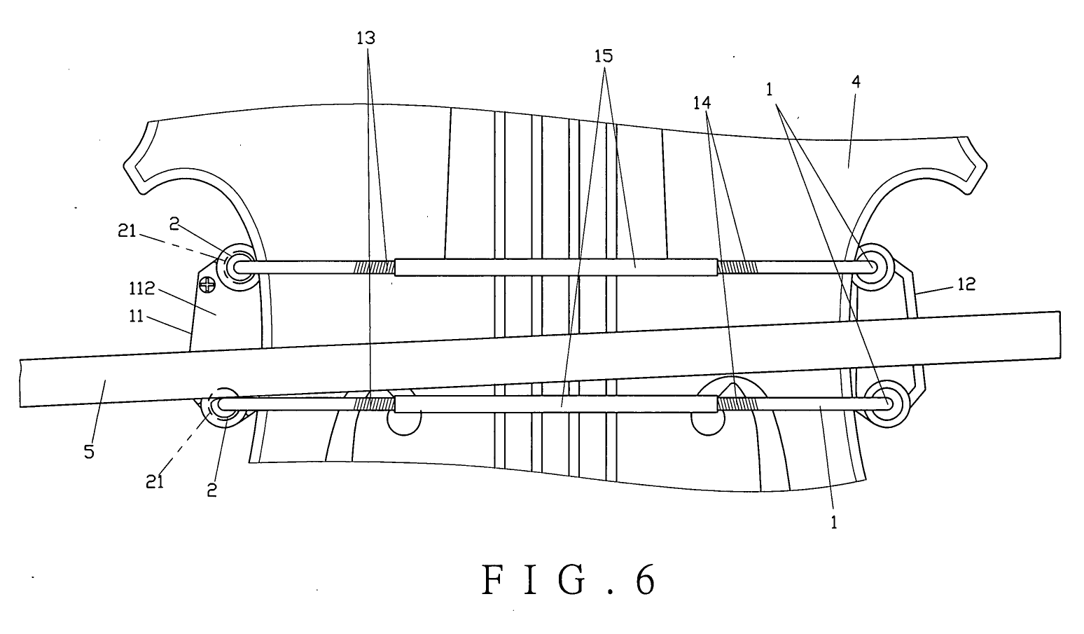

In practice, as shown in FIGS. 4 and 5, the two slots 111 and 121 of the two fixtures 11 and 12 of the restriction rods 1 are secured onto the edges of the violin 4. A bow 5 is confined in the two restriction rods 1 when a player plays the violin 4. When the player is not in a correct position, as shown in FIG. 6, the bow 5 will touch either of the touch rods 2, which turns on the switch 34 of the warning unit 3, and the control chip 32 is activated to trigger the buzzer 33 to buzz, thus to remind the player to correct his/her position.

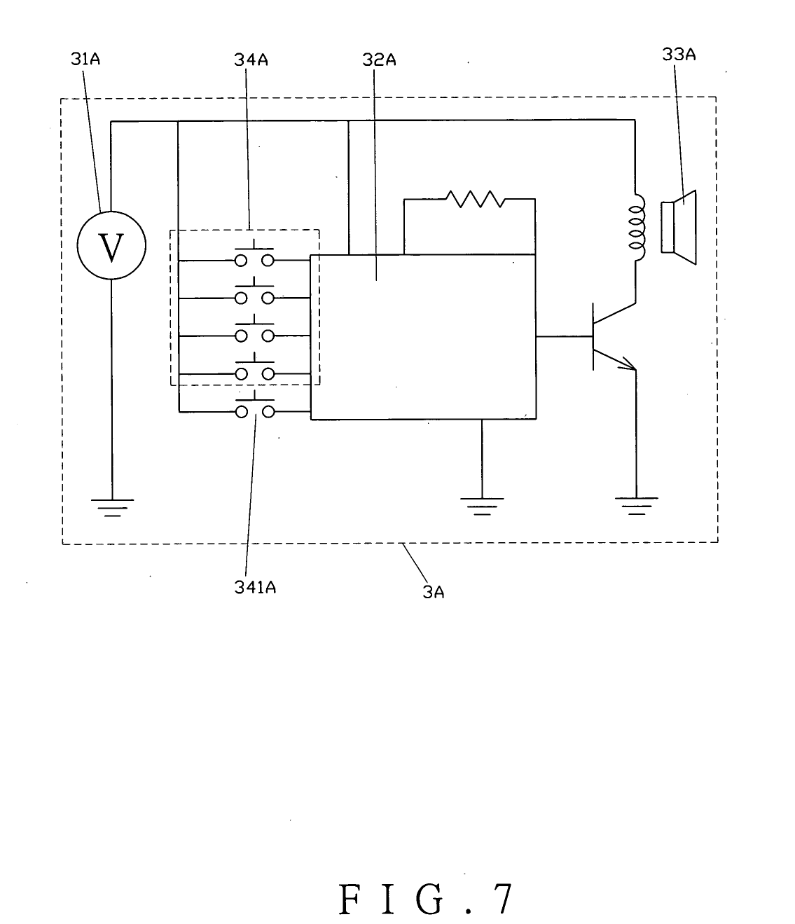

Every time the switch 34 is turned on, the control chip 32 is activated to trigger the buzzer 33 to buzz the same sound. The circuitry may be designed to a second embodiment, as shown in FIG. 7. A control chip 32A of a warning unit 3A is connected to a number of switches 34A and a main switch 341A. Every time when the touch rod 2 touches the restriction rod 1, as shown in FIG. 5, the main switch 341A is switched on and the control chip 32A outputs a signal through the switches 34A in turn, and a battery 31A provides electricity to trigger a buzzer 33A to buzz different sounds, which can attract the player's attention.

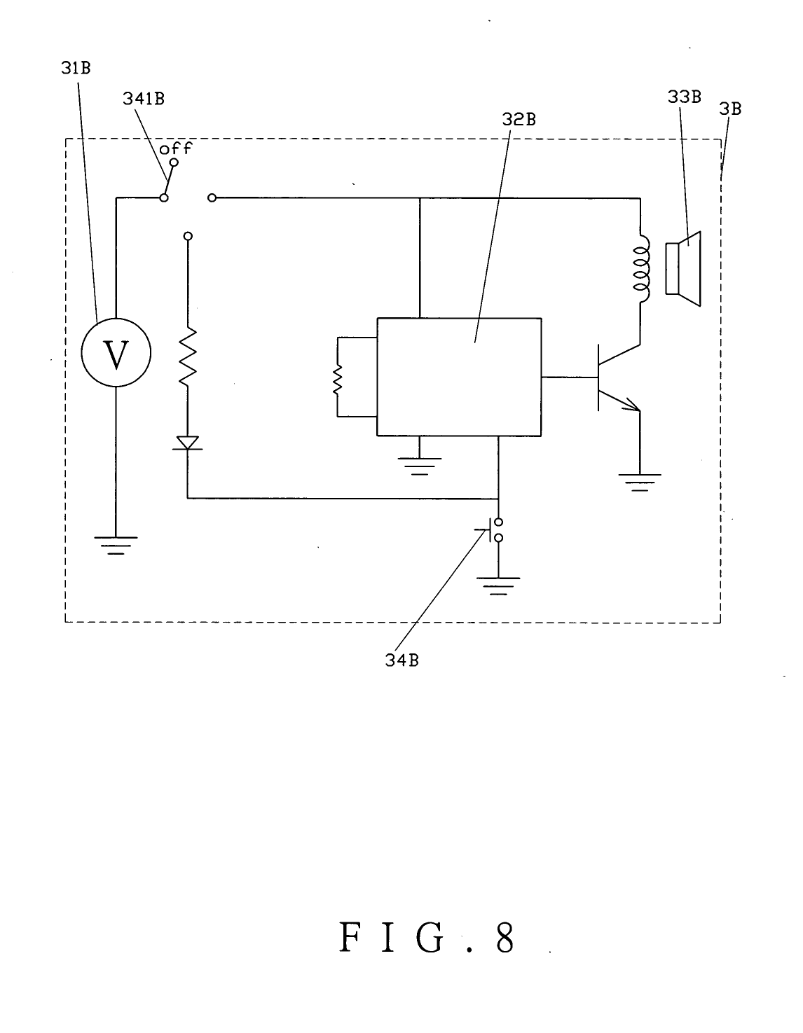

The circuitry of the present invention may be designed as shown in FIG. 8. A control chip 32B of a warning unit 3B is connected to a switch 34B and a power supply switch 341B. The power supply switch 341B is turned on first, every time the touch rod 2 touches the restriction rod 1, the switch 34B is switched on and the control chip 32B outputs a signal to trigger a buzzer 33B through the electricity from a battery 31B. The power supply switch 341B may be turned off to save power when the violin 4 is not in use.

I claim:

1. A violin practice reminder comprising restriction rods, fixtures, touch rods, and a warning unit;
said restriction rods, said touch rods and said warning unit being disposed on said fixtures;
said fixrures being secured to a violin;
said touch rods being disposed by said restriction rods,
said warning unit comprising a buzzer and a switch, said switch being connected to said restriction rods and said touch rods respectively, said buzzer being triggered to buzz when said touch rods are in touch with said restriction rods to turn on said switch.

2. The violin practice reminder, as recited in claim 1, wherein said touch rods are in a sprial shape to sleeve onto said restriction rods, said touch rods further cmprising washers at respective ends to insulate from said restriction rods.

3. The violin practice reminder, as recited in claim 2, wherein said touch rods and said restriction rods are made of electric material.

4. The violin practice reminder, as recited in claim 1, wherein each said restriction rod further comprises two sections inserted into a sleeve.

5. The violin practice reminder, as recited in claim 1, wherein said sleeve comprises a pair of threads inwardly with one in a clockwise direction and the other in a counterclockwise direction, horizontal portions of said two sections of each said restriction rod comprising a pair of threads corresponding to said threads of said sleeve for connection.

6. The violin practice reminder, as recited in claim 1, wherein said warning unit comprises a control chip to trigger said buzzer to buzz when said switch is turned on every time.
